(19) United States
(12) Patent Application Publication
(10) Pub. No.: US 2004/0165221 A1
(43) Pub. Date: Aug. 26, 2004

(54) Inquiry management system, inquiry management method, inquiry sorting system and inquiry sorting method

(76) Inventors: Taku Motohashi, Tokyo (JP); Hironobu Yamauchi, Tokyo (JP); Katsumi Sakamoto, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/762,580

(22) Filed: Jan. 23, 2004

(30) Foreign Application Priority Data
Jan. 31, 2003 (JP) 2003-023349
Jan. 31, 2003 (JP) 2003-023350

(51) Int. Cl. H04N 1/00; H04N 1/32

(52) U.S. Cl. 358/442; 358/400

(57) ABSTRACT

[Object] This invention provides an inquiry-management system and inquiry-management method that, when an inquiry regarding poor product quality or part specifications is received as FAX data, is capable of managing the inquiries sent as FAX data without having to output the FAX data on paper and is capable of keeping it together with the information-management form.

[Means to Solve] The invention comprises: a FAX-receiving unit 31 that receives FAX data and converts the received FAX data to FAX-image data that is in image format that can be viewed by a browser; an information-communication-form-creation unit 32 that creates an information-communication form that contains the FAX-image data and that is used for managing inquiries; an information-communication-form-memory unit 33 that stores the created information-communication-form; and an information-communication-form-management unit 35 that provides a browser screen comprising an input area for performing input to the information-communication-form, and a display area for displaying the FAX-image data.

### DETAILED DESCRIPTION OF THE INVENTION

1. Field of the Invention

This invention relates to an inquiry-management system and inquiry-management method of managing inquiries that used a FAX apparatus, and more particularly to an inquiry-management system and inquiry-management method that manage inquiries that used a FAX apparatus and that are related to poor quality of repair parts and part specifications.

Furthermore, the invention relates to an inquiry-sorting system and inquiry-sorting method of sorting, according to answering department, inquiries that used a FAX apparatus, and more particularly an inquiry-sorting system and inquiry-sorting method of sorting, according to answering department, inquiries that used a FAX apparatus and that are related to poor quality of repair parts and part specifications.

2. Description of the Related Art

Conventionally, inquiries from dealers that ordered repair parts for automobiles or the like regarding poor product quality or part specifications, and answers to those inquiries was performed by sending information using a FAX apparatus and telephone. In other words, the dealer sent an inquiry to the parts center that sent the repair parts by FAX apparatus or telephone to inquire about poor product quality or part specifications, and the parts center sent an inquiry to the managing department that receives inquiries by FAX apparatus or telephone to inquire about the poor product quality or part specifications. The managing department filled out an information-management form for managing the inquiry based on the received FAX, and selected an answering department to be in charge of answering the inquiry, then the selected department in charge, answered the inquiry regarding poor product quality or part specifications by FAX apparatus or telephone.

In patent document 1, a FAX-document-classification apparatus is disclosed that classifies FAX documents by attaching correspondence to keywords that correspond to ID information contained in part of the FAX document for each FAX document of a group of FAX documents that were received in one transmission, and displays the group of FAX documents one-by-one in order in the image-display area on a display screen, receives keywords that are input in the text input area and that correspond to each of displayed FAX documents, and stores the input keywords and each of the displayed FAX documents that are given an identifying image-file in the FAX-document-classification apparatus.

[Patent Document 1]

Japanese Patent Publication No. 2001-282814

[Problems to be Solved by the Invention]

However, in this conventional technique, when an inquiry regarding poor product quality or part specifications was received as FAX data, the FAX data was output as a FAX document on paper, and an information-management form was filled out based on the output FAX document, then the FAX document on paper is combined into a set with the information-management form to be managed, so there was a problem in that a large amount of paper was required and it was easy for the FAX document and information-management form to become separated.

Also, in the conventional technique, when an inquiry regarding poor product quality or part specifications was received as FAX data, the FAX data was output as a FAX document on paper, and an information-management form was filled out based on the output FAX document, and after selecting an answering department to answer the inquiry, the FAX document and information-management form were sent by FAX to the answering department, so there was a problem in that the work of sorting according to answering department became troublesome.

Taking these problems into consideration, the object of this invention is to provide an inquiry-management system and inquiry-management method that, when an inquiry regarding poor product quality or part specifications is received as FAX data, is capable of managing the inquiries sent as FAX data without having to output the FAX data on paper and is capable of keeping it together with the information-management form.

Moreover, a further object of the invention is to provide an inquiry-sorting system and inquiry-sorting method that, when an inquiry regarding poor product quality or part specifications is received as FAX data, is capable of simply sorting inquiries sent as FAX data according to the contents of the inquiry to the answering departments that will answer the inquiries.

[Means for Solving the Problems]

In order to solve the aforementioned problems, the invention is configured as describe below.

The invention of claim 1 is an inquiry-management system that manages inquiries received as FAX data and comprising: a FAX-receiving means of receiving FAX data and converting the received FAX data to FAX-image data that is in image format that can be viewed by a browser; an information-communication-form-creation means of creating an information-communication form that contains the FAX-image data converted by the FAX-receiving means and is used for managing inquiries; an information-communication-form-memory means of storing the information-communication-form created by the information-communication-form-creation means; and an input-screen-providing means of providing a browser screen comprising an input area for performing input to the information-communication-form that is stored in the information-communication-form-memory means, and a display area for displaying the FAX-image data.

The invention of claim 2 is the inquiry-management system of claim 1 wherein the information-communication form comprises; form information for identifying the information-communication form and identifying the inquiry source; part information for identifying the repair part that is the object of the inquiry; comments and answer comments.

The invention of claim 3 is the inquiry-management system of claim 2 wherein the FAX-receiving means outputs the sender's number and/or FAX header to the information-communication-form-creation means, and the information-communication-form-creation means performs input to the items of the form information based on the sender's number and/or FAX header.

The invention of claim 4 is the inquiry-management system of claim 2 or 3 wherein the part information, comments and answer comments of the information-communication form that is created by the information-communication-form-creation means are blank fields.

The invention of claim 5 is an inquiry-management method that manages inquiries received as FAX data and that: receives FAX data; converts the received FAX data to FAX-image data that is in image format that can be viewed by a browser; creates an information-communication form that contains the converted FAX-image data and is used for managing inquiries; stores the created information-communication-form; and provides a browser screen comprising an input area for performing input to the stored information-communication-form, and a display area for displaying the FAX-image data.

The invention of claim 6 is the inquiry-management method of claim 5 wherein the information-communication form comprises; form information for identifying the information-communication form and identifying the inquiry source; part information for identifying the repair part that is the object of the inquiry; comments and answer comments.

The invention of claim 7 is the inquiry-management method of claim 6 that performs input to the items of the form information based on the sender's number and/or FAX header.

The invention of claim 8 is the inquiry-management method of claim 6 or 7 wherein the part information, comments and answer comments of the created information-communication form are blank fields.

The invention of claim 9 is an inquiry-sorting system that sorts inquiries received as FAX data among answering departments that will answer the inquiries and comprising: an information-communication-form-creation means of receiving FAX data and creating an information-communication form for managing the inquiry; an information-communication-form-memory means of storing the information-communication form that was created by the information-communication-from-creation means; a form-screen-providing means of providing the managing terminal with a browser screen that comprises an inquiry-contents-input area for inputting inquiry contents into the information-communication form that is stored in the information-communication-form-memory means, and designating an answering terminal according to the input inquiry contents; and an inquiry-answer-screen-providing means of providing the answering terminal that was designated by the input of the inquiry contents with a browser screen that comprises an answer-comment-input area for inputting answer comments into the information-communication form that is stored in the information-communication-form-memory unit.

The invention of claim 10 is the inquiry-sorting system of claim 9 wherein the information-communication-form-creation means sends an information-communication-form-creation notification to the managing terminal to notify that an information-communication-form has been created.

The invention of claim 11 is the inquiry-sorting system of claim 9 or 10 wherein the form-screen-providing means sends an inquiry-request notification to the answering terminal when an inquiry instruction is received from the managing terminal.

The invention of claim 12 is the inquiry-sorting system of any of the claims 9 to 11 wherein the answer-screen-providing means sends an answer-complete notification to the inquiry-source terminal when an instruction to answer an inquiry is received from the answering terminal.

The invention of claim 13 is an inquiry-sorting method that sorts inquiries received as FAX data among answering departments that will answer the inquiries and: receives FAX data and creates an information-communication form for managing the inquiry; stores the created information-communication form; provides the managing terminal with a browser screen that comprises an inquiry-contents-input area for inputting inquiry contents into the stored information-communication; designates an answering terminal according to the input inquiry contents; and provides the answering terminal that was designated by the input of the inquiry contents with a browser screen that comprises an answer-comment-input area for inputting answer comments into the stored information-communication form.

The invention of claim 14 is the inquiry-sorting method of claim 13 that sends an information-communication-form-creation notification to the managing terminal to notify that an information-communication-form has been created.

The invention of claim 15 is the inquiry-sorting method of claim 13 or 14 that sends an inquiry-request notification to the answering terminal when an inquiry instruction is received from the managing terminal.

The invention of claim 16 is the inquiry-sorting method of any of the claims 13 to 15 that sends an answer-complete notification to the inquiry-source terminal when an instruction to answer an inquiry is received from the answering terminal. [Effect of the Invention]

With the inquiry-management system and inquiry-management method of this invention, by creating an information-communication form that is in a format that can be viewed using a Web browser and that contains FAX-image data, and by providing a browser screen that comprises an input area for performing input to the information-communication form and a display area for displaying FAX-image data, it is possible to perform input to the information-communication form while viewing the FAX-image data at the terminal, so when an inquiry regarding poor product quality or part specifications is received as FAX data, it is possible to manage the inquiry that was sent as FAX data without having to output the FAX data on paper and it is possible to keep that inquiry together with the information-communication form, so it is effective in making it possible to make the work of managing inquiries more efficient.

Also, a browser screen is provided to the managing terminal that comprises an inquiry-contents-input area for inputting inquiry contents in the information-communication form, and an answering terminal is designated according to the input inquiry contents, so when an inquiry regarding poor product quality or part specifications is received as FAX data, it is possible to easily sort the inquiries sent as FAX data according to the inquiry contents to an answering department that will answer the inquiry, and is effective in making it possible to especially make the work of sorting inquiries to answering departments more efficient.

### DESCRIPTION OF THE PREFERRED EMBODIMENT

The preferred embodiment of the invention will be explained below based on the drawings.

FIG. 1 is a block diagram showing the construction of an embodiment of the inquiry-management system, and a block diagram showing the construction of an embodiment of the inquiry-sorting system of the invention;

FIG. 2 is a drawing showing an example of the inquiry form that was sent from the FAX apparatuses shown in FIG. 1;

FIG. 3 is a drawing showing an example of the information-communication form that is created by the management-communication-form-creation unit shown in FIG. 1;

FIG. 4 is a drawing showing an example of the form screen that is provided by the information-communication-form-management unit shown in FIG. 1;

FIG. 5 is a drawing showing an example of the inquiry-comparative-table that is stored in the information-communication-form-management unit shown in FIG. 1;

FIG. 6 is drawing showing an example of an inquiry-instruction screen that is provided by the information-communication-form-management unit shown in FIG. 1; and

FIG. 7 is a drawing showing an example of an inquiry-answer screen this is provided by the information-communication-form-management unit shown in FIG. 1.

As shown in FIG. 1, this embodiment comprises: FAX apparatuses 1a to 1c that are located at the source of the inquiry such as a dealer that ordered repair parts, or the parts center that sent repair parts, and are connected to a public-line network such as analog-line network, or digital-line network; an inquiry-management apparatus 3 that is connected to the public-line network 2 and a network 4 such as the Internet; answering terminals 6a to 5c that are located at the answering department that answers the inquiries and are connected to the network 4; inquiry-source terminals 6a to 6c that are located at the inquiry source and are connected to the network 4; and a management terminal 7 that is located at the managing department that manages the inquiries and is connected to the network 4.

The FAX apparatuses 1a to 1c are G3 facsimiles that perform data transmission using an analog-line network, or G4 facsimiles that perform data transmission using a digital-line network such as ISDN. As shown in FIG. 2, the inquiry form 8 that is sent by FAX from the FAX apparatuses 1a to 1c has a management-number-input field, a base-code-input field, inquirer-name-input field, and illustration entry field, and the inquiring party fills in the necessary items, and then sends the form by FAX to the inquiry-management apparatus 3.

As shown in FIG. 1, the inquiry-management apparatus 3 comprises: a FAX-receiving unit 31, information-communication-form-creation unit 32, information-communication-form-memory unit 33, FAX-image-data-memory unit 34, information-communication-form-management unit 35 and information-sending/receiving unit 32, and functions as a Web server.

The FAX-receiving unit 31 has the function of receiving FAX data from the FAX apparatuses 1a to 1c by way of the public-line network 2, and it converts the received FAX data to an image format that can be viewed by a Web browser, such as TIFF (Tagged Image File Format) or PNG (Portable Network Graphics), and outputs the converted image data to the information-communication-form-creation unit 32 as FAX-image data. Also, the FAX-receiving unit 31 outputs the sender's number and the FAX header that was contained in the FAX data to the information-communication-form-creation unit 32 together with the FAX-image data.

After the information-communication-form-creation unit 32 receives the FAX-image data from the FAX-receiving unit 31, it creates an information-communication form comprising the contents of the inquiry, the form information, part information, FAX-image data, comments, and answer comments; and stores the contents of the inquiry, form information, part information, comments and answer comments in the information-communication-form-memory unit 33, and stores the FAX-image data in the FAX-image-data-memory unit 34 and correlates them with each other. The form information, is information that identifies the created information-communication form and identifies the source of the inquiry, and the form information items include, for example, the system-management number, inquiry-reception date, name of person in charge, base code, base telephone number, base FAX number, etc. Also, the parts information is information for identifying the repair parts that are the object of the inquiry, and the part information items include, for example, the part number, part name, make and model, year, etc.

Moreover, the information-communication-form-creation unit 32 performs input for the items of form information of the created information-communication form based on the sender's number and FAX header. In other words, information corresponding to the sender's number and the FAX header are defined beforehand in the information-communication-form-creation unit 32, and the information that corresponds to the received sender's number and FAX header is input in the appropriate location. As possible information that can be input by the information-communication-form-creation unit 32 is the reception date of the inquiry, the person in charge, base code, base name, base telephone number, base FAX number, etc. The information-communication form is created with blank fields (no input) for the items that were input based on the sender's number and FAX header, and items, part information, comments, and answer comments other that the FAX-image data.

It is also possible to add various kinds of management information to the information-communication form created by the information-communication-creation unit 32 that is related to the inquiry in addition to the form information, part information, FAX-image data, comments and answer comments, and the added management information could include, information for analysis of the inquiry contents, information related to the product quality of the repair part being inquired about, information related to returning the repair part being inquired about, etc.

Furthermore, when creating the information-communication form, the information-communication-form-creation unit 32 sends an information-communication-form-creation notification to the managing terminal 7 by way of the information-sending/receiving unit 36 and network 4 to notify that an information-communication form was created according to an inquiry (received FAX) from the inquiry source. Sending the information-communication-form-creation notification does not have to be sent every time an information-communication form is created, but can also be creased periodically, for example, once a day; and in that case, it is preferred that the number of information-communication forms created be included in the information-communication-form-creation notification.

The information-communication-form-management unit 35 is a means of managing access to the information-communication form that is stored in the information-communication-form-memory unit 33, and together with providing an input screens for the information-communication form, it also manages searching and viewing of the information-communication form. Providing an input screens for the information-communication form by the information-communication-form-management unit 35 includes providing a form screen 11 for performing input of form information, part information and comment information in the information-communication form and providing an inquiry-instruction screen for giving an instruction for an inquiry to the managing terminal 7, as well as providing an inquiry-answer screen 300 for inputting answer comments in the information-communication form to the answering terminals 5a to 5c. The form screen 100, inquiry-instruction screen 200 and inquiry-answer screen 300 are browser screens that can be viewed using a Web browser.

As shown in FIG. 4, the form screen 100 that is provided by the information-form-management unit 35 comprises: a cancel button 101 that gives an instruction to return to the previous screen, a save button 102 that gives an instruction to temporarily save the input data, an inquiry confirmation button 103 that gives an instruction to input data related to the input data, an inquiry-contents-input area 104 in which the contents of the inquiry are input, a form-information-input area 105 in which form information is input, a parts-information-input area 106 in which part information is input, a comment-input area 107 in which comments are input, and a FAX-image-data-display area 108 in which the FAX-image data is displayed.

An inquiry-comparative table as shown in FIG. 5, which correlates a plurality of preset inquiry contents with answering departments, is stored in the information-communication-management unit 35, and input into the inquiry-contents-input field 104 is performed by selecting and inputting one of the plurality of preset items of inquiry contents, and the answering department is set according to that input.

On the form screen, when the input to the inquiry-contents-input area 104, form-information-input area 105, part-information-input area 16 and comment-input area 107 is performed and the inquiry-confirmation button 103 is clicked, the information-communication-form-management unit 35 reads the data related to the data input in the form-information-input area 105 and part-information-input area 106 from a database (not shown in the figure) and inputs information for the items with no input, and provides the inquiry-instruction screen 200. By clicking on the inquiry-confirmation button 103, the input for the items with no input, such as information from the base code, to the base name and base telephone number that are input in the form-information-input area 105 is input, and information from the part number to the part name that are input in the part-information-input area 106 is input.

The inquiry-instruction screen 200 that is provided by the information-communication-form-management unit 35 comprises: a cancel button 101, a save button 102, a delete button 201 that gives an instruction to delete input contents, an inquiry button 202 that gives an instruction to execute the inquiry to the answering department, an inquiry-contents-input area 104, form-information-input area 105, part-information-input area 106, comment-input area 107, and FAX-image-data-display area 108 where the FAX-image data is displayed. Also, on the inquiry-instruction screen 200 when there is an item having the same part number as that in the information-communication form that is saved in the information-communication-form-memory unit 33, the character string reference-past-record 203 is displayed, and by clicking on that character string, it is possible to reference the past information-communication form having the same part number.

The inquiry-answer screen 300 that is provided by the information-communication-form-management unit 35 comprises: a cancel button 101, an answer button 301 that executes the answer to an inquiry, an inquiry-contents-display area 302, a form-information-display area 303, a part-information-display area 304, comment-display area 305, answer-comment-input area 306 and Fax-image-data-display area 108.

Also, when the inquiry button 202 is clicked on the inquiry-instruction screen 200, the information-communication-form-management unit 35 sends an inquiry-request notification to an answering terminal 5a to 5c located at the answering department according to the input inquiry contents, and when the answer button 301 is clicked on the inquiry-answer screen 300, it sends an answer-complete notification to the inquiry-source terminal 6a to 6c located at the inquiry source. The inquiry-request notification and answer-complete notification are performed by e-mail, for example. Instead of sending the inquiry-request notification and inquiry-complete notification every time that the inquiry button 202 and answer button 301 are clicked on, they can be sent periodically, such as once a day.

On the form screen 100, inquiry-instruction screen 200 and inquiry-answer screen 300, it is possible to display the FAX-image data after receiving a display instruction, instead of displaying the FAX-image data in advance on the form screen 100.

The information-sending/receiving unit 36 has the function of performing information communication among the answering terminals 5a to 5c, inquiry-source terminals 6a to 6c and managing terminal 7 using HTTP (HyperText Transfer Protocol) via the network 4.

The answering terminals 5a to 5c, inquiry-source terminals 6a to 6c and managing terminal 7 are information processing apparatuses such as a personal computer in which Web browser and e-mail software are installed, and they have the function of performing information communication with the information-sending/receiving unit 36 using HTTP (HyperText Transfer Protocol) via the network 4.

Next, the operation of this embodiment will be explained in detail with reference to FIG. 8.

FIG. 8 is a drawing explaining the operation of an embodiment of the inquiry-management system of this invention, and an embodiment of an inquiry-management method of this invention.

First, an inquiry form 8 is sent by FAX from FAX apparatus 1 that is located at a dealer or parts center to the inquiry-management apparatus 3 (step 1).

The FAX-receiving unit 31 receives the FAX data from the FAX apparatus 1 via the public-line network 2, and converts the received FAX data image format such as TIFF (Tagged Image File Format) or PNG (Portable Network Graphics), then outputs the converted image data to the information-communication-form-creation unit 32 as FAX-image data. The information-communication-form-creation unit 32 receives the FAX-image data and creates an information-communication form comprising inquiry contents, form information, part information, FAX-image data, comments and answer comments; and together with storing the inquiry contents, form information, part information, comments and answer comments in the information-communication-form memory unit 33, and storing the FAX-image data in the FAX-image-data-memory unit 34, it sends an information-communication-form-creation notification to the managing terminal 7 to notify that the information-communication form was created according to a inquiry (received by FAX) from the inquiry source via the information-sending/receiving unit 36 and network 4 (step 2).

Next, when the managing party receives the information-communication-form-creation notification and knows that an information-communication form has been created, the managing party accesses the inquiry-management apparatus 3 from the managing terminal 7 via the network 4, and on the form screen 100 that is provided by the information-communication-form-management unit 35, inputs the inquiry contents, form information, part information and comments and clicks on the inquiry-confirmation button 103, and on the inquiry-instruction screen 200, after checking the input contents, clicks on the inquiry button 202 (step 3).

When the inquiry button 202 is clicked on inquiry-instruction screen 200, the information-communication-form-management unit 35 sends an inquiry-request notification to the answering terminal 5a to 5c located at the answering department that was designated by the input inquiry contents (step 4).

Next, after receiving the inquiry-request notification and knowing that an inquiry has been requested, the answering party accesses the inquiry-management apparatus 3 from the answering terminal 5 via the network 4, and on the inquiry-answer screen 300 provided by the information-communication-form-management unit 35, inputs answer comments and then clicks on the inquiry-answer button 301 (step 5).

When the answer button 301 is clicked on the inquiry-answer screen 300, the information-communication-form-management unit 35 sends an answer-complete notification to the inquiry-source terminal 6a to 6c located at the inquiry source (step 6).

Next, after receiving the answer-complete notification and knowing that the answer has been completed, the inquirer can obtain the answer to the inquiry by accessing the inquiry-management apparatus 3 from the inquiry-source terminal 6 via the network 4 and viewing the information-communication form.

As explained above, with this embodiment, by creating an information-communication form that is in a format that can be viewed using a Web browser and that contains FAX-image data, and by providing a browser screen that comprises an input area for performing input to the information-communication form and a display area for displaying FAX-image data, it is possible to perform input to the information-communication form while viewing the FAX-image data at the terminal, so when an inquiry regarding poor product quality or part specifications is received as FAX data, it is possible to manage the inquiry that was sent as FAX data without having to output the FAX data on paper and it is possible to keep that inquiry together with the information-communication form, so it is effective in making it possible to make the work of managing inquiries more efficient.

Also, with this embodiment, a browser screen is provided to the managing terminal that comprises an inquiry-contents-input area for inputting inquiry contents in the information-communication form, and an answering terminal is designated according to the input inquiry contents, so when an inquiry regarding poor product quality or part specifications is received as FAX data, it is possible to easily sort the inquiries sent as FAX data according to the inquiry contents to an answering department that will answer the inquiry, and is effective in making it possible to especially make the work of sorting inquiries to answering departments more efficient.

The invention is not limited to the embodiment described above, and it is evident that the embodiment can be adequately changed within the range of the technical scope of the invention. Also, the number, location and form of the components is not limited to that of the embodiment described above, and it is possible to use a number, location and form that is suitable to the invention. In the drawings, the same reference numbers are used for identical components.

### BRIEF DESCRIPTION OF THE DRAWINGS

FIG. 1 is a block diagram showing the construction of an embodiment of the inquiry-management system and inquiry-sorting system of the invention.

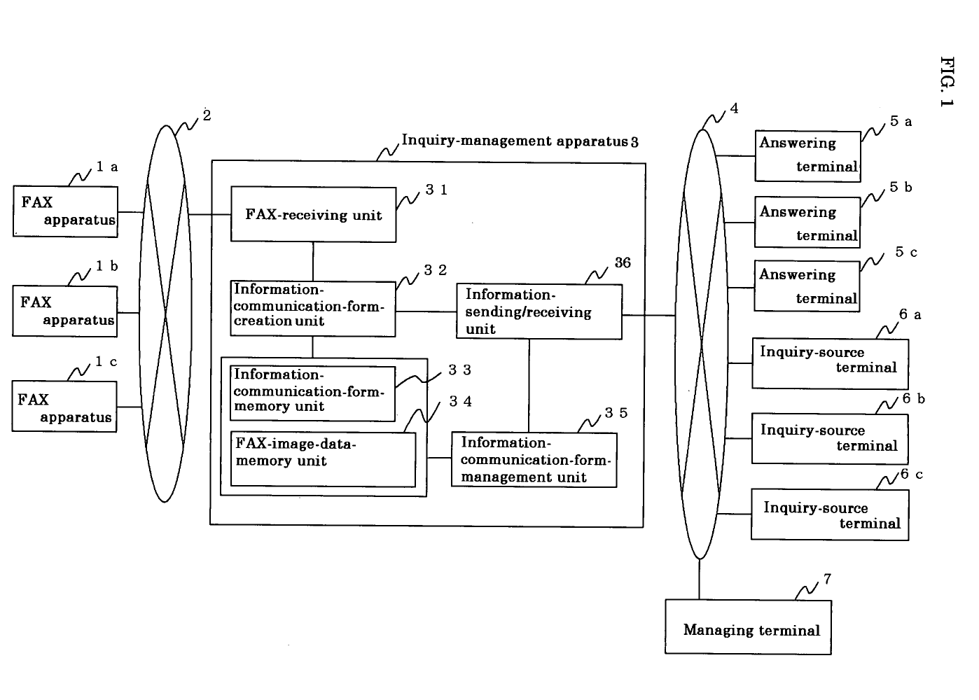

FIG. 2 is a drawing showing an example of the inquiry form that was sent from the FAX apparatuses shown in FIG. 1.

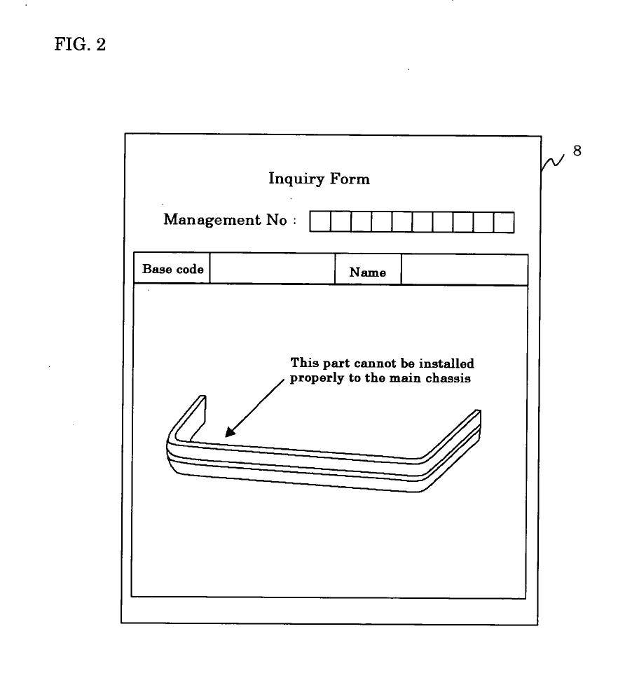

FIG. 3 is a drawing showing an example of the information-communication form that is created by the management-communication-form-creation unit shown in FIG. 1.

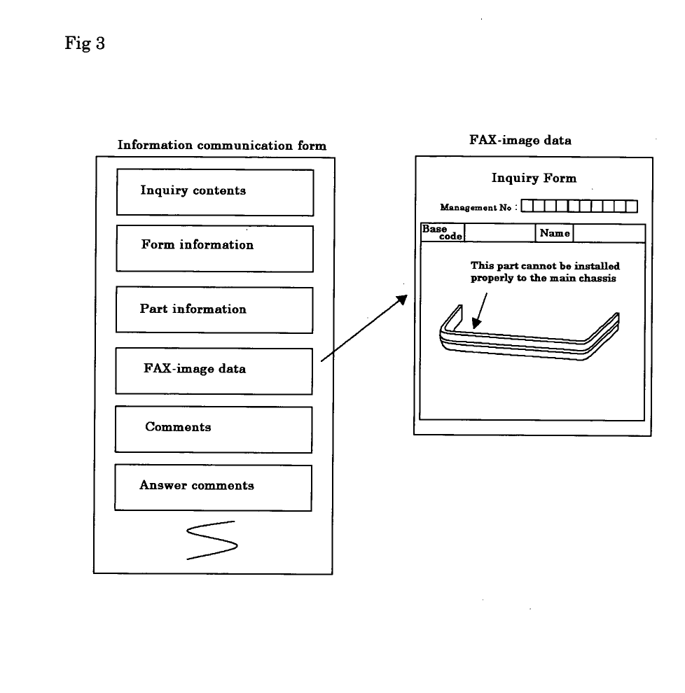

FIG. 4 is a drawing showing an example of the form screen that is provided by the information-communication-form-management unit shown in FIG. 1.

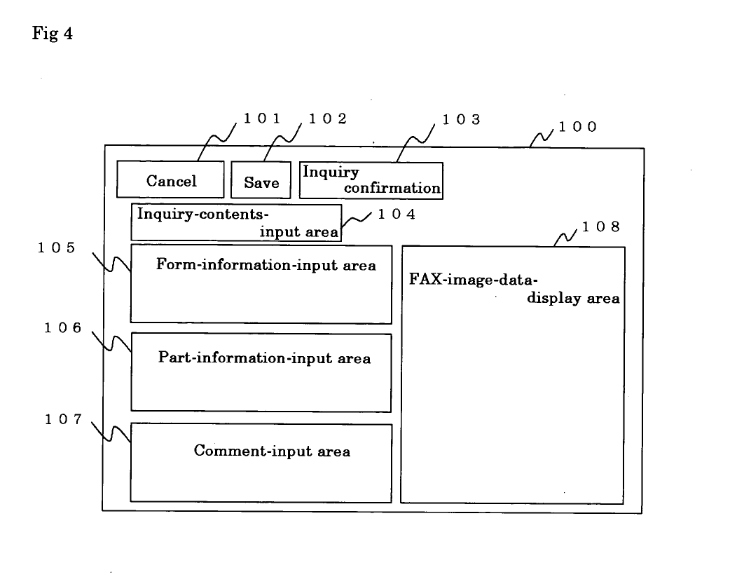

FIG. 5 is a drawing showing an example of the inquiry-comparative-table that is stored in the information-communication-form-management unit shown in FIG. 1.

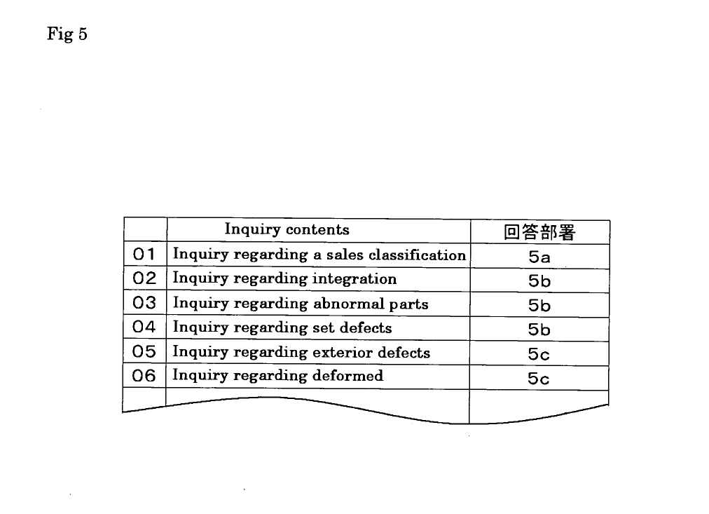

FIG. 6 is drawing showing an example of an inquiry-instruction screen that is provided by the information-communication-form-management unit shown in FIG. 1.

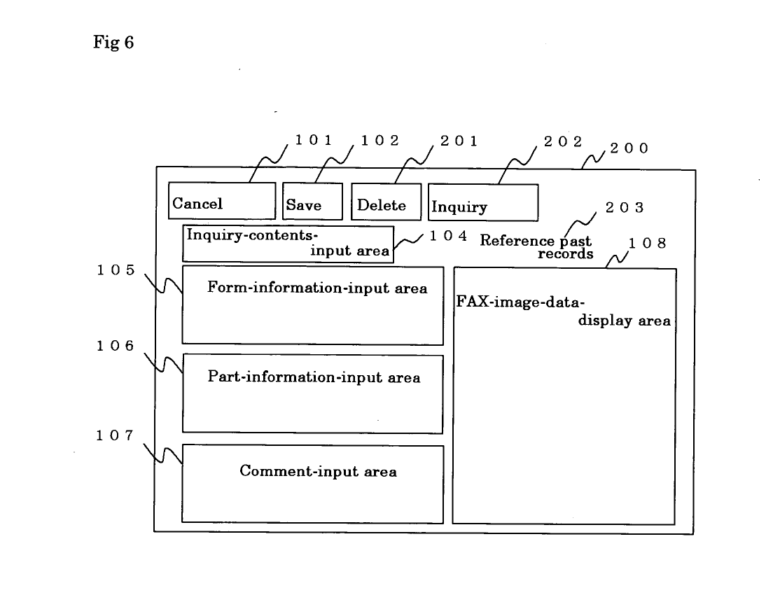

FIG. 7 is a drawing showing an example of an inquiry-answer screen this is provided by the information-communication-form-management unit shown in FIG. 1.

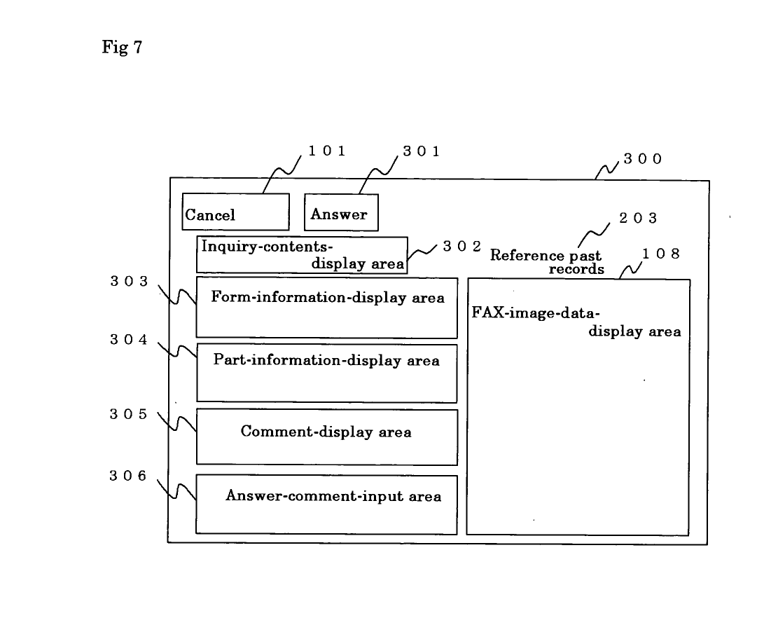

FIG. 8 is a drawing explaining the operation of an embodiment of the inquiry-management system and inquiry-management method of this invention.

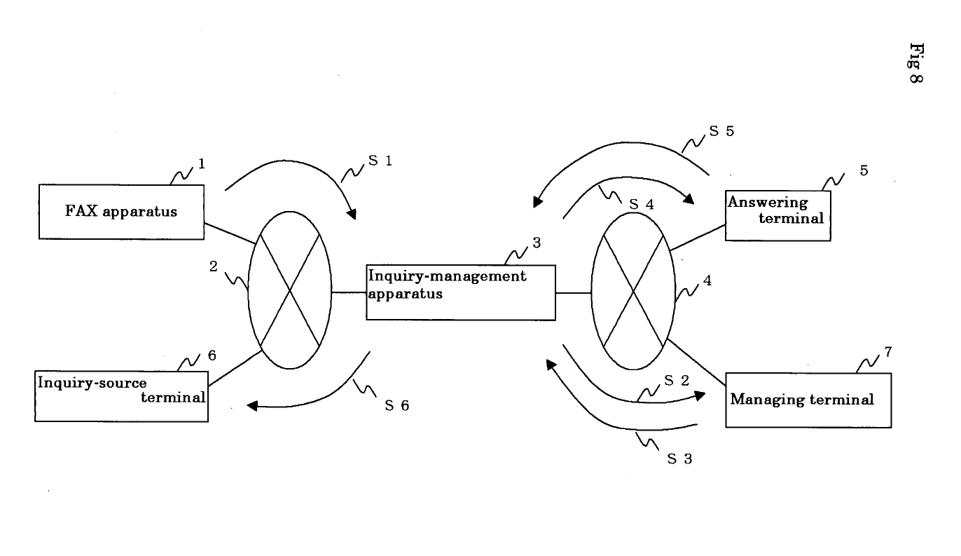

### Description of Reference Numbers

1. 1a-1c FAX apparatuses

2. public-line network

3. inquiry-management apparatus

4. network

5. 5a-5c answering terminals

6. 6a-6c inquiry-source terminals

7. management terminal

8. inquiry form

31. FAX-receiving unit

32. information-communication-form-creation unit

33. information-communication-form-memory unit

34. FAX-image-data-memory unit

35. information-communication-form-management unit

36. information-sending/receiving unit

100. form screen

101. cancel button

102. save button

103. inquiry confirmation button

104. inquiry-contents-input area

105. form-information-input area

106. parts-information-input area

107. comment-input area

108. FAX-image-data-display area

200. inquiry-instruction screen

201. delete button

202. inquiry button

203. reference-past-record

300. inquiry-answer screen

301. answer button

302. inquiry-contents-display area

303. form-information-display area

304. part-information-display area

305. comment-display area

306. answer-comment-input area

What is claimed is:

1. An inquiry-management system that manages inquiries received as FAX data and comprising:
a FAX-receiving means of receiving said FAX data and converting said received FAX data to FAX-image data that is in image format that can be viewed by a browser;
an information-communication-form-creation means of creating an information-communication form that contains said FAX-image data converted by said FAX-receiving means and is used for managing said inquiries;
an information-communication-form-memory means of storing said information-communication-form created by said information-communication-form-creation means; and
an input-screen-providing means of providing a browser screen comprising an input area for performing input to said information-communication-form that is stored in said information-communication-form-memory means, and a display area for displaying said FAX-image data.

2. The inquiry-management system of claim 1 wherein
said information-communication form comprises; form information for identifying said information-communication form and identifying the inquiry source; part information for identifying the repair part that is the object of the inquiry; comments and answer comments.

3. The inquiry-management system of claim 2 wherein
said FAX-receiving means outputs the sender's number and/or FAX header to said information-communication-form-creation means, and
said information-communication-form-creation means performs input to the items of said form information based on the sender's number and/or FAX header.

4. The inquiry-management system of claim 2 or 3 wherein
said part information, comments and answer comments of said information-communication form that is created by said information-communication-form-creation means are blank fields.

5. An inquiry-management method that manages inquiries received as FAX data and that:
receives said FAX data;
converts said received FAX data to FAX-image data that is in image format that can be viewed by a browser;
creates an information-communication form that contains said converted FAX-image data and is used for managing said inquiries;
stores said created information-communication-form; and
provides a browser screen comprising an input area for performing input to said stored information-communication-form, and a display area for displaying said FAX-image data.

6. The inquiry-management method of claim 5 wherein
said information-communication form comprises; form information for identifying said information-communication form and identifying said inquiry source; part information for identifying the repair part that is the object of the inquiry; comments and answer comments.

7. The inquiry-management method of claim 6 that performs input to the items of said form information based on the sender's number and/or FAX header.

8. The inquiry-management method of claim 6 or 7 wherein
said part information, comments and answer comments of said created information-communication form are blank fields.

9. An inquiry-sorting system that sorts inquiries received as FAX data among answering departments that will answer the inquiries and comprising:
an information-communication-form-creation means of receiving said FAX data and creating an information-communication form for managing said inquiry;
an information-communication-form-memory means of storing said information-communication form that was created by said information-communication-from-creation means;
a form-screen-providing means of providing the managing terminal with a browser screen that comprises an inquiry-contents-input area for inputting inquiry contents into said information-communication form that is stored in said information-communication-form-memory means, and designating an answering terminal according to the input inquiry contents; and
an inquiry-answer-screen-providing means of providing the answering terminal that was designated by the input of the inquiry contents with a browser screen that comprises an answer-comment-input area for inputting answer comments into said information-communication form that is stored in said information-communication-form-memory unit.

10. The inquiry-sorting system of claim 9 wherein
said information-communication-form-creation means sends an information-communication-form-creation notification to said managing terminal to notify that said information-communication-form has been created.

11. The inquiry-sorting system of claim 9 or 10 wherein
said form-screen-providing means sends an inquiry-request notification to said answering terminal when an inquiry instruction is received from said managing terminal.

12. The inquiry-sorting system of any of the claims 9 to 11 wherein
said answer-screen-providing means sends an answer-complete notification to said inquiry-source terminal when an instruction to answer said inquiry is received from said answering terminal.

13. An inquiry-sorting method that sorts inquiries received as FAX data among answering departments that will answer the inquiries and:
receives said FAX data and creates an information-communication form for managing said inquiry;
stores said created information-communication form;
provides the managing terminal with a browser screen that comprises an inquiry-contents-input area for inputting inquiry contents into said stored information-communication form;
designates an answering terminal according to the input inquiry contents; and
provides the answering terminal that was designated by the input of the inquiry contents with a browser screen that comprises an answer-comment-input area for inputting answer comments into said stored information-communication form.

14. The inquiry-sorting method of claim 13 that sends an information-communication-form-creation notification to said managing terminal to notify that said information-communication-form has been created.

15. The inquiry-sorting method of claim 13 or 14 that sends an inquiry-request notification to said answering terminal when an inquiry instruction is received from said managing terminal.

16. The inquiry-sorting method of any of the claims 13 to 15 that sends an answer-complete notification to said inquiry-source terminal when an instruction to answer said inquiry is received from said answering terminal.
